(19) United States
(12) Patent Application Publication
(10) Pub. No.: US 2008/0134230 A1
(43) Pub. Date: Jun. 5, 2008

(54) APPARATUS AND METHOD FOR EXTRACTING CONDITIONAL ACCESS INTERNAL MESSAGE IN MOBILE MULTIMEDIA BROADCASTING SYSTEM

(75) Inventors: Jin-Kyu Kim, Daejon (KR); Bon-Tae Koo, Daejon (KR); Nak-Woong Eum, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 11/928,231

(22) Filed: Oct. 30, 2007

(30) Foreign Application Priority Data
Dec. 4, 2006 (KR) 10-2006-0121629
Apr. 10, 2007 (KR) 10-2007-0035238

(51) Int. Cl. H04N 7/16

(52) U.S. Cl. 725/25

(57) ABSTRACT

Provided is an apparatus and method for extracting a conditional access internal message which can efficiently extract a conditional access internal message including an entitlement control message (ECM)/entitlement management message (EMM) without fast information channel (FIC) of a digital multimedia broadcasting (DMB) frame in a mobile multimedia broadcasting system. The conditional access internal message extracting apparatus includes: a sub-channel data extracting unit for extract sub-channel data associated with conditional access from a mobile multimedia broadcasting signal; a sub-channel prefix header analyzing unit configured to extract sub-channel prefix length information from a sub-channel prefix length field of the sub-channel data, and extract start position information of a conditional access internal message from the sub-channel; and a sub-channel prefix data processor configured to extract the conditional access internal message from the sub-channel data by using the sub-channel prefix length information and the start position information of the conditional access internal message.

### CROSS-REFERENCE(S) TO RELATED APPLICATIONS

The present invention claims priority of Korean Patent Application Nos. 10-2006-0121629 and 10-2007-0035238, filed on Dec. 4, 2006, and Apr. 10, 2007, respectively, which are incorporated herein by reference.

### BACKGROUND OF THE INVENTION

1. Field of the Invention

The present invention relates to an apparatus and method for extracting a conditional access internal message in a mobile multimedia broadcasting system; and, more particularly, to an apparatus and method for extracting a conditional access internal message in a mobile multimedia broadcasting system, which are configured to extract a conditional access internal message, i.e., an entitlement control message (ECM)/entitlement management message (EMM) from sub-channel data by using sub-channel prefix length information extracted from the sub-channel data and start position information of the conditional access internal message.

This work was partly supported by the Information Technology (IT) research and development program of the Korean Ministry of Information and Communication (MIC) and/or the Korean Institute for Information Technology Advancement (IITA) [2005-S-010-02, “Development of Low Power SoC Technology for Bidirectional Terrestrial DMB”].

2. Description of Related Art

A digital multimedia broadcasting (DMB) system will be described herein as an example of mobile multimedia broadcasting systems. Thus, it should be understood that the present invention is not limited to the DMB system.

In Korea, DMB system is being provided free of charge. However, data service such as transport protocol expert group (TPEG) will be provided on payment basis. In order to access a pay service, a user must be entitled to the service via a user authentication process from a conditional access system (CAS) provider. Therefore, a DMB receiver or a receiver chip needs to have a function for processing a conditionally accessible signal.

FIG. 1 illustrates a conventional DMB frame format for conditional access. Referring to FIG. 1, the DMB frame format includes one fast information channel (FIC) and four common interleaving frames (CIF). The FIC includes a fast information block (FIB), and each CIF may include data of a plurality of services.

The plurality of services may include a conditionally accessible service. In this case, data of a sub-channel 11 (hereinafter, referred to as sub-channel data) begins with a sub-channel prefix 110 and ends with a data signal 120 scrambled for the conditional access.

The sub-channel prefix 110 includes a 1-byte prefix header 111, an m-3 (m=multiple of 24 bytes) byte prefix data field 112, and a 2-byte cyclic redundancy check (CRC) field 113 in this order. “m” is limited to the multiple of 24, and this is because information based on “Eureka-147 DAB” is transmitted only as a multiple of 8 kbps.

First, the prefix header 111 includes a plurality of flags, and the flags are as follows:

FF (First Flag): flag that indicates start of packet

LF (Last Flag): flag that indicates end of packet

PI (Packet ID): packet identifier

PP (Padded Packet Indicator): padded packet indicator

CI (Continuity Index): continuity index

CWT (Control Word Toggle): index that indicates change of control word.

The FF and the LF indicate a position of a corresponding packet in a message including a sequence of packets.

The PI indicates an ID of a logical transmission channel, and thus serves to distinguish several kinds of control access (CA) internal messages being transmitted. The CA internal message includes an entitlement control message (ECM) and an entitlement management message (EMM).

The PP indicates the presence of data length information in the prefix data field 112. In detail, when the PP is “1”, the length information of the prefix data field 112 follows after the prefix header 111. When the PP is “0”, the length information is omitted.

The CI increases by one for each added sub-channel within the same logical channel. The CWT changes from “0” to “1” or “1” to “0” when a control word changes.

The prefix data field 112 follows immediately after the prefix header 111. The prefix data field 112 includes prefix data field length information, initial count information used for “128-bit advanced encryption standard (AES)”, and a CA internal message, i.e., an ECM/EMM provided by a CAS provider.

The position of the 2-byte initial count field varies according to the PP value. In detail, when the PP is “1”, the 2-byte initial count follows after the 1-byte prefix data field length information. When the PP is “0”, the 2-bte initial count field follows immediately after the prefix header 111. The initial count value is used as an initial count value of the AES when a conditionally accessible signal is encrypted in an AES counter mode.

The sub-channel data for conditional access is based on the “specification of the conditional access for terrestrial Digital Multimedia Broadcasting (T-DMB) transmitter” developed by the Telecommunication Technology Association (TTA).

FIG. 2 is a block diagram of a conventional DMB receiver unit for conditional access. Referring to FIG. 2, the conventional DMB receiver unit for conditional access includes a DMB receiver 21, a CA processor/host interface 22, a source decoder 23, a host processor 24, and a CAS module 25.

In detail, the DMB receiver 21 receives a radio frequency (RF) signal to perform baseband-signal processing, and then outputs sub-channel source signals corresponding to respective services. The sub-channel source signals include a DMB broadcasting signal encoded by an H.264 video encoder and a BSAC audio encoder, a MUSICAM audio signal, and a packet signal for a data service. Pay services among those services are output in a scrambled state through a CA system.

Thereafter, the CA processor/host interface 22 transmits a CA sub-channel signal selected by a user to the host processor 24. The host processor 24 performs processing in two different ways according to the processing method of the CA process.

First, when the CA processor/host interface 22 unscrambles scrambled data, the host processor 24 reads sub-channel data 11 through the host interface, extracts an ECM/EMM from the sub-channel data 11 by using corresponding sub-channel prefix length information in an FIC field of a received DMB frame, and transmits the extracted message to the CAS module 25.

Thereafter, the CAS module 25 analyzes the EMM and examines the entitlement of a subscriber. When the subscriber status is available, the CAS module 25 analyzes the ECM, then generates a control word, and transmits the control word to the host processor 24.

Then, the host processor 24 transmits the control word to the CA processor/host interface 22.

Then, the CA processor/host interface 22 unscrambles the scrambled data by using the control word transmitted from the host processor 24, thereby transmitting normal service data to the source decoder 23.

Secondly, when the host processor 24 not only unscrambles the scrambled data but also processes a sub-channel prefix 110, the CA processor/host interface 22 serves simply as a host interface that transmits entire sub-channel data including sub-channel prefix data to the host processor.

That is, the host processor 24 reads the sub-channel data 11 through the host interface, and extracts an ECM/EMM from the sub-channel data 11 by using corresponding sub-channel prefix length information included in the FIC field of the received DMB frame. Thereafter, the host processor transmits the extracted ECM/EMM to the CAS module 25 to obtain a control word, and also unscrambles the scrambled data using the obtained control word.

The conventional DMB receiver unit has limitations of deterioration of DMB reception/processing performance. This is because when lengths of sub-channel prefixes 110 frequently vary and re-multiplexing is performed, the FIC field of the DMB frame must be checked whenever a CA internal message is extracted from sub-channel data.

Also, a cost of the conventional DMB receiver increases since an expensive CA processor (host processor) is provided in order to analyze a sub-channel prefix of each CIF frame in real-time.

### SUMMARY OF THE INVENTION

An embodiment of the present invention is directed to providing an apparatus and method for extracting a conditional access internal message in a multimedia broadcasting system, which can efficiently extract a conditional access internal message including an entitlement control message (ECM)/entitlement management message (EMM) without referring to a fast information channel (FIC) of a digital multimedia broadcasting (DMB) frame by extracting the ECM/EMM from sub-channel data using sub-channel prefix length information extracted from the sub-channel data, and start position information of the conditional access internal message.

In accordance with an aspect of the present invention, there is provided an apparatus for extracting a conditional access internal message in a mobile multimedia broadcasting system, which includes: a sub-channel data extracting unit configured to extract sub-channel data associated with conditional access from a mobile multimedia broadcasting signal; a sub-channel prefix header analyzing unit configured to extract sub-channel prefix length information from a sub-channel prefix length field of the sub-channel data, and extract start position information of a conditional access internal message from the sub-channel; and a sub-channel prefix data processor configured to extract the conditional access internal message from the sub-channel data by using the sub-channel prefix length information and the start position information of the conditional access internal message.

The apparatus further includes a storage unit configured to consecutively store divided conditional access internal messages transmitted from the sub-channel prefix data processing unit, and output a complete conditional access internal message.

In accordance with another aspect of the present invention, there is provided a method for extracting a conditional access internal message, which includes the steps of: a) extracting sub-channel data associated with conditional access from a mobile multimedia broadcasting signal; b) extracting sub-channel prefix length information from a sub-channel prefix length field of the extracted sub-channel data; c) extracting start position information of a conditional access internal message from the extracted sub-channel data; and d) extracting the conditional access internal message from the sub-channel data by using the extracted sub-channel prefix length information and the extracted start position information of the conditional access internal message.

The method further includes the step of e) consecutively storing divided conditional access internal messages and outputting a complete conditional access internal message.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 illustrates a conventional DMB frame format for conditional access.

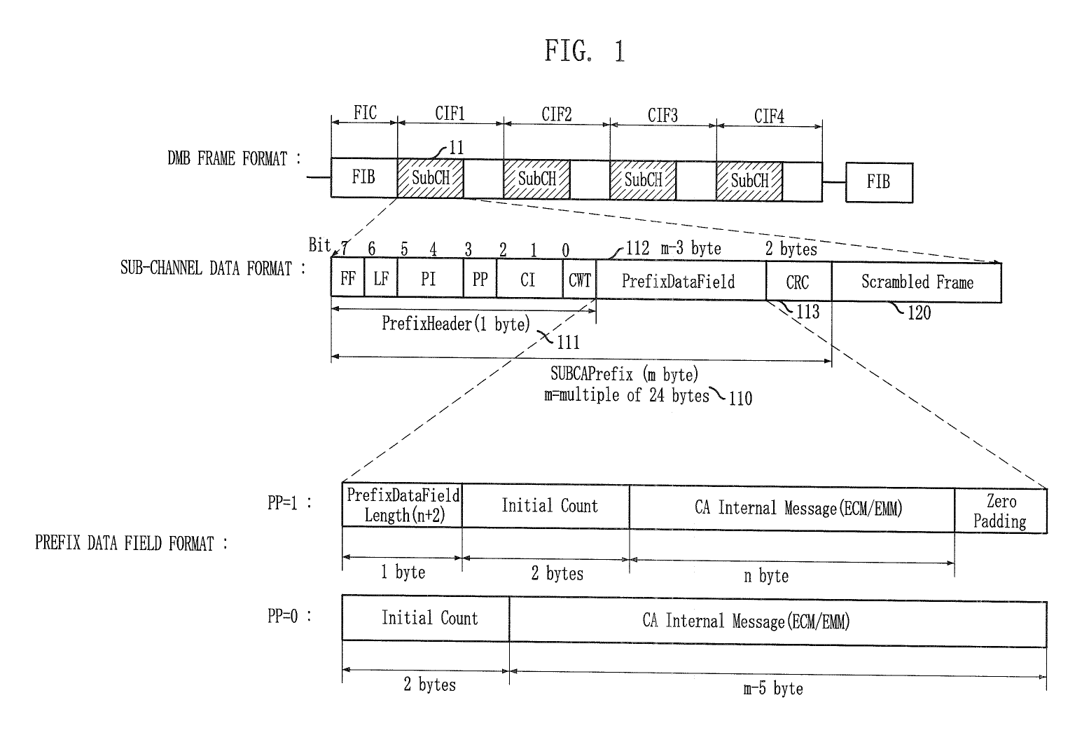

FIG. 2 is a block diagram of a conventional DMB receiver unit.

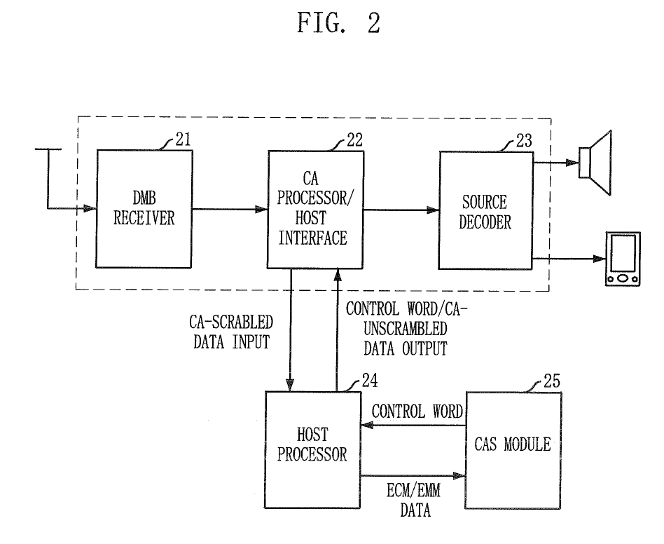

FIG. 3 illustrates a DMB frame format for conditional access in accordance with an embodiment of the present invention.

FIG. 4 is a block diagram of an apparatus for extracting a conditional access internal message in a mobile multimedia broadcasting system in accordance with an embodiment of the present invention; and

FIG. 5 is a flowchart of a method for extracting a conditional access internal message in a mobile multimedia broadcasting system in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

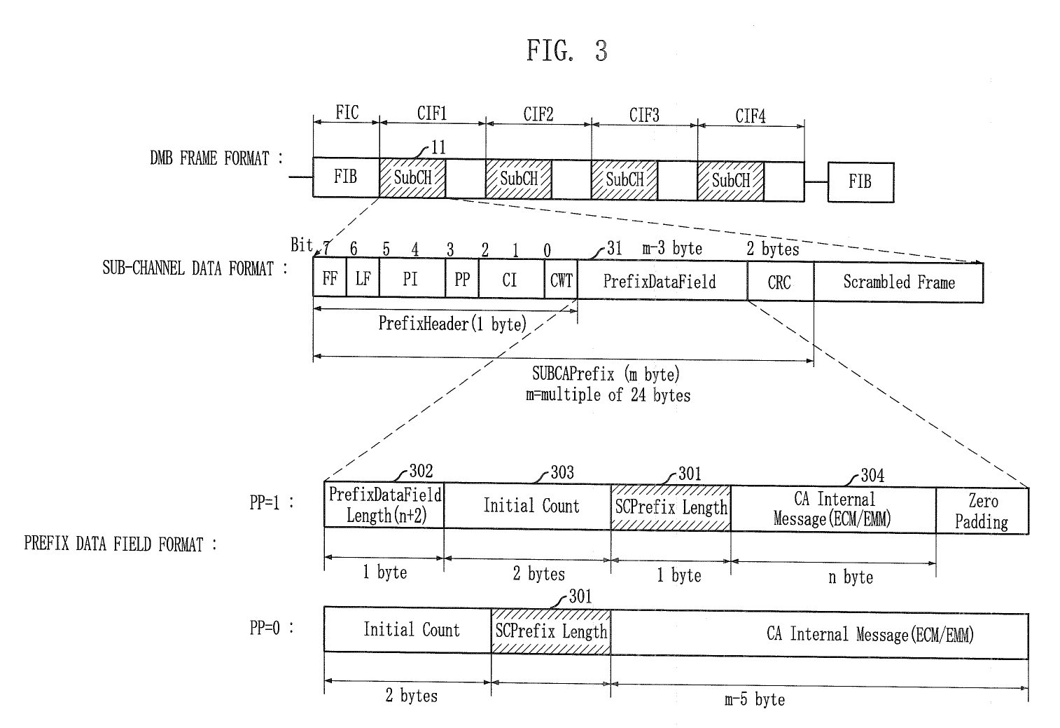

FIG. 3 illustrates a digital multimedia broadcasting (DMB) frame for conditional access in accordance with an embodiment of the present invention.

Referring to FIG. 3, a prefix data field 31 of the DMB frame includes a 1-byte prefix data length field 302, a 2-byte initial count field 303, a 1-byte sub-channel prefix length field 301, and a conditional access (CA) internal message field 304.

When a CA internal message, i.e., an entitlement control message (ECM)/entitlement management message (EMM) is extracted from sub-channel data, the ECM/EMM can be simply extracted by using sub-channel prefix length information stored in the sub-channel prefix length field 301 of the corresponding sub-channel data.

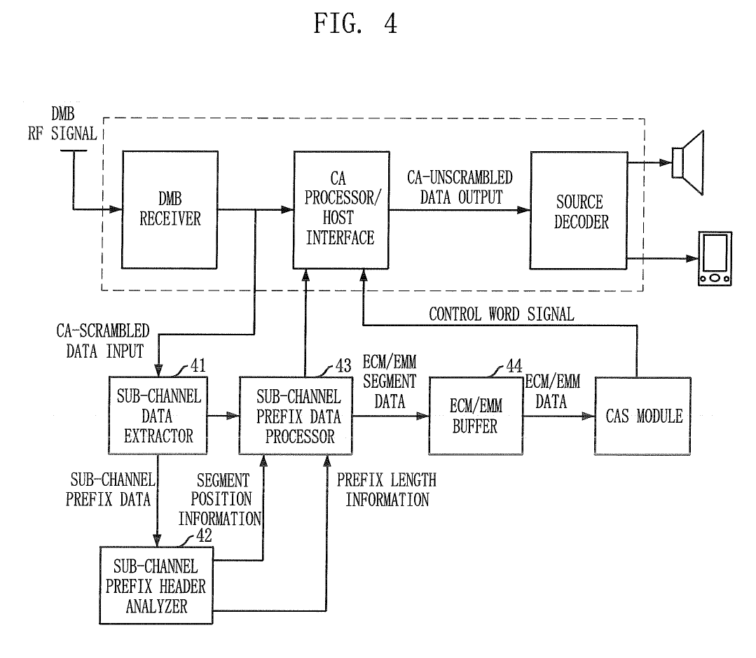

FIG. 4 is a block diagram of an apparatus for extracting a CA internal message in a mobile multimedia broadcasting system in accordance with an embodiment of the present invention.

Referring to FIG. 4, the apparatus for extracting a CA internal message in a mobile multimedia broadcasting system in accordance with an embodiment of the present invention includes a sub-channel data extractor 41, a sub-channel prefix header analyzer 42, and a sub-channel prefix data processor 43. The sub-channel data extractor 41 is configured to extract sub-channel data corresponding to a sub-channel ID associated with conditional access from a DMB signal received by a DMB receiver unit.

The sub-channel prefix header analyzer 42 is configured to extract sub-channel prefix length information from the sub-channel length field (SCPrefix Length) 301 of the sub-channel data extracted by the sub-channel data extractor 41, and to extract start position information of a CA internal message, i.e., an ECM/EMM from the sub-channel data extracted by the sub-channel data extractor 41.

Also, the sub-channel prefix header analyzer 42 is configured to transfer the extracted information to the sub-channel prefix data processor 43. The sub-channel prefix data processor 43 is configured to extract the CA internal message from the sub-channel data by using the sub-channel prefix length and the start position information of the CA internal message extracted by the sub-channel prefix header analyzer 42.

The apparatus for extracting a CA internal message in a mobile multimedia broadcasting in accordance with an embodiment of the present invention further includes a buffer i.e., an ECM/ECC buffer. The buffer is configured to consecutively store divided CA internal messages transferred from the sub-channel prefix data processor 43, and thus to output a complete CA internal message to a conditional access system (CAS) module.

The DMB receiver unit for conditional access employing the present invention includes the CAS module (hereinafter, referred to as a “control word generator”), and a CA processor. The control word generator is configured to authenticate a user by using the complete CA internal message stored in the buffer, i.e., using the EMM, and then generate a control word by using the ECM. The CA processor unscrambles scrambled sub-channel signals by using an initial count value transmitted directly from the sub-channel prefix header analyzer 42 or transmitted through the sub-channel prefix data processor 43, and the control word generated by the control word generator.

The sub-channel data extractor 41 further performs error detection through a cyclic redundancy check (CRC) field included in the extracted sub-channel data. For example, the sub-channel data extractor 41 may be implemented as an input interface.

The sub-channel prefix header analyzer 42 determines a position of an ECM/EMM segment of ECM/EMM data according to values of a first flag (FF) and a last flag (LF), and determines whether the segment corresponds to the ECM or the EMM according to a value of a packet identifier (PI) flag.

The sub-channel prefix header analyzer 42 determines the presence of prefix data field length field according to a padded packet indicator (PP) flag.

Also, the sub-channel prefix header analyzer 42 extracts an initial count value used for descrambling, and transfers the initial count value to the CA processor via the sub-channel prefix data processor 43. Of course, the sub-channel prefix header analyzer 42 may extract an initial count value used for descrambling, and transmit the initial count value directly to the CA processor without using the sub-channel prefix data processor 43.

The sub-channel prefix header analyzer 42 determines a start position of the CA internal message, i.e., the ECM/EMM segment in due consideration of the fact that the prefix data length field 302 is added when the PP is 1, and is omitted when the PP is 0.

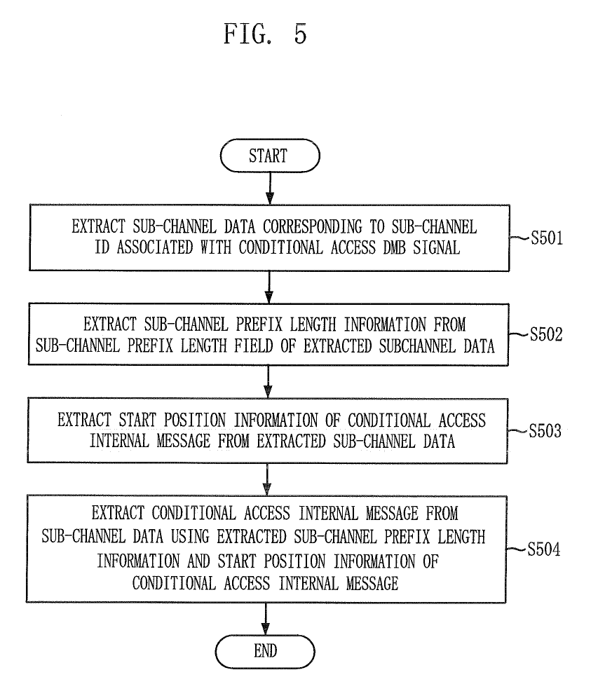

FIG. 5 is a flowchart of a method for extracting a CA internal message in a mobile multimedia broadcasting system in accordance with an embodiment of the present invention.

In step S501, the sub-channel data extractor 41 extracts sub-channel data corresponding to a sub-channel ID associated with conditional access from a DMB signal, and transfers the sub-channel data to the sub-channel prefix header analyzer 42.

In step S502, the sub-channel prefix header analyzer 42 extracts sub-channel prefix length information from the sub-channel length field (SCPrefix Length) 301 of the sub-channel data.

In step S503, the sub-channel prefix header analyzer 42 extracts start position information of a CA internal message from the extracted sub-channel data.

In step S504, the sub-channel prefix data processor 43 extracts the CA internal message from the sub-channel data by using the extracted sub-channel prefix length information and the start position information of the CA internal message.

CA internal messages extracted in such a manner are stored in a corresponding buffer, and are transferred to the control word generator.

Then, the control word generator authenticates a user by using an EMM, and then generates a control word by using an ECM, and transfers the control word to the CA processor.

Thereafter, the CA processor unscrambles scrambled sub-channel signals by using the initial count value transferred directly from the sub-channel prefix header analyzer 42 or transferred through the sub-channel prefix data processor 43, and the control word generated by the control word generator.

According to embodiments of the present invention, a CA internal message, i.e., an ECM/EMM is extracted from sub-channel data by using sub-channel prefix length information extracted from the sub-channel data, and start position information of the CA internal message. Accordingly, the CA internal message can be efficiently extracted without referring to a fast information channel (FIC) of a DMB frame.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

While the present invention has been described with respect to the specific embodiments, it will be apparent to those skilled in the art that various changes and modifications may be made without departing from the spirit and scope of the invention as defined in the following claims.

What is claimed is:

1. An apparatus for extracting a conditional access internal message in a mobile multimedia broadcasting system, comprising:
a sub-channel data extracting unit configured to extract sub-channel data associated with conditional access from a mobile multimedia broadcasting signal;
a sub-channel prefix header analyzing unit configured to extract sub-channel prefix length information from a sub-channel prefix length field of the sub-channel data, and extract start position information of a conditional access internal message from the sub-channel; and
a sub-channel prefix data processor configured to extract the conditional access internal message from the sub-channel data by using the sub-channel prefix length information and the start position information of the conditional access internal message.

2. The apparatus of claim 1, further comprising a storage unit configured to consecutively store divided conditional access internal messages transmitted from the sub-channel prefix data processing unit, and output a complete conditional access internal message.

3. The apparatus of claim 1, wherein the sub-channel prefix header analyzing unit is configured to analyze a header of the sub-channel data and extract the start position information of the conditional access internal message according to a padded packet indicator (PP) field value.

4. The apparatus of claim 3, wherein the conditional access internal message comprises:
an entitlement management message (EMM) used for user authentication; and
an entitlement control message (ECM) used for control-word generation.

5. A method for extracting a conditional access internal message, comprising the steps of:
a) extracting sub-channel data associated with conditional access from a mobile multimedia broadcasting signal;
b) extracting sub-channel prefix length information from a sub-channel prefix length field of the extracted sub-channel data;
c) extracting start position information of a conditional access internal message from the extracted sub-channel data; and
d) extracting the conditional access internal message from the sub-channel data by using the extracted sub-channel prefix length information and the extracted start position information of the conditional access internal message.

6. The method of claim 5, further comprising the step of e) consecutively storing divided conditional access internal messages and outputting a complete conditional access internal message.

7. The method of claim 5, wherein the step c) comprises the step of analyzing a header of the sub-channel data to extract the start position information of the conditional access internal message according to a padded packet indicator (PP) field value.

8. The method of claim 7, wherein the conditional access internal message comprises:
an entitlement management message (EMM) used for user authentication; and
an entitlement control message (ECM) used for control-word generation.
